(19) United States
(12) Patent Application Publication
(10) Pub. No.: US 2021/0057721 A1
(43) Pub. Date: Feb. 25, 2021

(54) LITHIUM ION SECONDARY BATTERY

(71) Applicant: NEC CORPORATION, Tokyo (JP)

(72) Inventors: Daisuke KAWASAKI, Tokyo (JP); Takashi OHTSUKA, Tokyo (JP); Kazuhiko INOUE, Tokyo (JP)

(73) Assignee: NEC CORPORATION, Tokyo (JP)

(21) Appl. No.: 16/767,286

(22) PCT Filed: Nov. 21, 2018
(86) PCT No.: PCT/JP2018/042973

§ 371 Date: May 27, 2020

(30) Foreign Application Priority Data
Nov. 28, 2017 (JP) 2017-227647

(51) Int. Cl. H01M 4/134; H01M 10/0525; H01M 4/525; H01M 4/38; H01M 4/66; H01M 4/62; H01M 10/0569; H01M 10/0567

(52) U.S. Cl. CPC H01M 4/134; H01M 10/0525; H01M 4/525; H01M 4/386; H01M 2004/021; H01M 4/622; H01M 10/0569; H01M 10/0567; H01M 2220/20; H01M 4/661

(57) ABSTRACT

Provided is a lithium ion secondary battery having high energy density and excellent cycle characteristics, and hardly causing burning. The present invention relates to a lithium ion secondary battery comprising an electrode mixture layer comprising an electrode active material comprising Si alloy having a median diameter of 1.2 μm or less and 12% by weight or more and 50% by weight or less of an electrode binder; and an electrolyte solution comprising 60% by volume or more and 99% by volume or less of a phosphoric acid ester compound, 0% by volume or more and 30% by volume or less of a fluorinated ether compound, and 1% by volume or more and 35% by volume or less of a fluorinated carbonate compound, wherein the total amount of the phosphoric acid ester compound and the fluorinated ether compound is 65% by volume or more.

### TECHNICAL FIELD

The present invention relates to a lithium ion secondary battery, a method of manufacturing the same, and a vehicle, an assembled battery and the like comprising the lithium ion secondary battery.

### BACKGROUND ART

Lithium ion secondary batteries have advantages such as high energy density, low self-discharge, excellent long-term reliability and the like, and therefore they have been put into practical use in notebook-type personal computers, mobile phones and the like. Furthermore, in recent years, in addition to high functionality of electronic devices, by expansion of the market for motor-driven vehicles such as electric vehicles and hybrid vehicles, and acceleration of development of home and industrial power storage systems, development of a high performance lithium ion secondary battery which is excellent in battery characteristics such as cycle characteristics and storage characteristics and further improved in capacity and energy density has been demanded.

As a negative electrode active material for providing a high-capacity lithium ion secondary battery, metal-based active materials such as silicon, tin, and alloys and metal oxides containing them have attracted attention. However, while these metal-based negative electrode active materials provide high capacity, the expansion and contraction of the active materials during absorbing and desorbing lithium ions is large. Due to the volume change of expansion and contraction, the negative electrode active material particles collapse during repeated charge and discharge, resulting in that the new active surface is exposed. This active surface has had a problem of decomposing the solvent of the electrolyte solution and deteriorating the cycle characteristics of the battery. In addition, lithium ion secondary batteries require not only improved cycle characteristics but also safety.

Various studies have been made to improve battery characteristics of lithium ion secondary batteries. For example, Patent Document 1 describes an electrode comprising a negative electrode active material comprising silicon oxide, and a binder comprising alginate. Patent Document 2 discloses a lithium ion secondary battery comprising a negative electrode active material containing silicon oxide as a main component and a flame-retardant electrolyte solution containing a phosphoric acid ester. Patent Document 3 discloses an electrode material for a lithium secondary battery comprising particles of a solid-state alloy containing silicon as a main component.

### CITATION LIST

### Patent Document

Patent Document 1: WO2015/141231
Patent Document 2: WO2012/029551
Patent Document 3: Japanese Patent Laid-Open Publication No. 2004-311429

### SUMMARY OF INVENTION

### Technical Problem

These days, a lithium ion secondary battery comprising an electrode having a higher energy density than the electrode described in Patent Document 1 has been required. However, when the silicon content is increased, the aggregation of silicon is likely to occur and some silicon may not contribute to charge and discharge. In addition, since silicon has a large volume change associated with absorbing and desorbing lithium, there has still remained a problem that the cycle characteristics during charge and discharge are deteriorated. Thus, further improvement has been required. Patent Document 2 discloses a lithium ion secondary battery comprising a negative electrode active material comprising silicon oxide as a main component, but the study on the lithium ion secondary battery comprising a negative electrode active material comprising a large amount of a silicon alloy having a larger capacity than silicon oxide is insufficient. Patent Document 3 discloses an electrode material comprising a silicon alloy, but does not discuss battery safety, such as the flammability of an electrolyte solution.

### Solution to Problem

One aspect of the present example embodiment relates to the following matter.

A lithium ion secondary battery comprising an electrode and an electrolyte solution, wherein

the electrode comprises (i) an electrode mixture layer comprising an electrode active material and an electrode binder, and (ii) an electrode current collector;

the electrode active material comprises an alloy comprising silicon (Si alloy),

the Si alloy has a median diameter (D50 particle size) of 1.2 μm or less,

an amount of the electrode binder based on the weight of the electrode mixture layer is 12% by weight or more and 50% by weight or less; and

the electrolyte solution comprises:

60% by volume or more and 99% by volume or less of a phosphoric acid ester compound,

0% by volume or more and 30% by volume or less of a fluorinated ether compound, and

1% by volume or more and 35% by volume or less of a fluorinated carbonate compound, and wherein

the total amount of the phosphoric acid ester compound and the fluorinated ether compound is 65% by volume or more.

### Advantageous Effect of Invention

According to the present invention, there is provided a lithium ion secondary battery having a high energy density and excellent cycle characteristics, and hardly causing burning.

### BRIEF DESCRIPTION OF DRAWING

FIG. 1 is a sectional view of a lithium ion secondary battery according to one example embodiment of the present invention.

FIG. 2 is a schematic sectional view showing a structure of an electrode element of a stacking laminate type secondary battery according to one example embodiment of the present invention.

FIG. 3 is an exploded perspective view showing a basic structure of a film-packaged battery.

FIG. 4 is a sectional view schematically showing a section of the battery in FIG. 3.

### DESCRIPTION OF EXAMPLE EMBODIMENTS

One aspect of the lithium ion secondary battery of the present example embodiment comprises an electrode and an electrolyte solution, wherein

the electrode comprises (i) an electrode mixture layer comprising an electrode active material and an electrode binder, and (ii) an electrode current collector;

the electrode active material comprises an alloy comprising silicon (Si alloy),

the Si alloy has a median diameter (D50 particle size) of 1.2 μm or less,

an amount of the electrode binder based on the weight of the electrode mixture layer is 12% by weight or more and 50% by weight or less; and

the electrolyte solution comprises:

60% by volume or more and 99% by volume or less of a phosphoric acid ester compound,

0% by volume or more and 30% by volume or less of a fluorinated ether compound, and

1% by volume or more and 35% by volume or less of a fluorinated carbonate compound, and wherein

the total amount of the phosphoric acid ester compound and the fluorinated ether compound is 65% by volume or more.

The lithium ion secondary battery of the present example embodiment has a high energy density and excellent cycle characteristics, and hardly causing burning.

The lithium ion secondary battery (also simply referred to as “secondary battery”) according to the present example embodiment will be described in detail for each constituting member. In this specification, “cycle characteristics” means characteristics such as a capacity retention ratio after repeating the charge and discharge.

### <Electrode>

In the present example embodiment, the electrode comprises (i) an electrode mixture layer comprising an electrode active material and an electrode binder, and (ii) an electrode current collector; wherein the electrode active material comprises an alloy comprising silicon (Si alloy), and the Si alloy has a median diameter (D50 particle size) of 1.2 μm or less, and an amount of the electrode binder based on the weight of the electrode mixture layer is 12% by weight or more and 50% by weight or less. This electrode serves as a negative electrode in a full-cell lithium ion secondary battery.

In the present specification, the “positive electrode” and the “negative electrode” mean the positive electrode and the negative electrode in a full cell of a lithium ion secondary battery, respectively, unless otherwise described. In the following description, an electrode comprising a Si alloy will be described as a “negative electrode” as one preferable embodiment of the present example embodiment. In a half-cell in which metallic lithium is used as a counter electrode, the electrode comprising the Si alloy has a higher potential, but the absorption of lithium ions into the electrode comprising the Si alloy is referred to as charge.

### (Negative Electrode)

The negative electrode may have a structure in which a negative electrode mixture layer comprising a negative electrode active material is formed on a negative electrode current collector. A negative electrode of the present example embodiment comprises, for example, a negative electrode current collector formed of a metal foil or the like and a negative electrode mixture layer formed on one surface or both surfaces of the negative electrode current collector. The negative electrode mixture layer is formed so as to cover the negative electrode current collector with a negative electrode binder. The negative electrode current collector is arranged to have an extended portion connected to a negative electrode terminal, and the negative electrode mixture layer is not formed on the extended portion. Here, in the present specification, the “negative electrode mixture layer” refers to a portion other than the negative electrode current collector among the constituent elements of the negative electrode, and comprises a negative electrode active material and a negative electrode binder, and may comprise, as necessary, an additive such as an electrically conductive assistant agent. The negative electrode active material is a material capable of absorbing and desorbing lithium. In the present specification, a substance that does not absorb and desorb lithium, such as a binder, is not included in the negative electrode active material.

The negative electrode in one embodiment of the present example embodiment comprises:

(i) a negative electrode mixture layer comprising a negative electrode active material and a negative electrode binder and

(ii) a negative electrode current collector, wherein

the negative electrode active material comprises a Si alloy,

the Si alloy has a median diameter (D50 particle size) of 1.2 μm or less, and

an amount of the negative electrode binder based on the total weight of the negative electrode mixture layer is 12% by weight or more and 50% by weight or less.

### (Negative Electrode Active Material)

In the present example embodiment, the negative electrode active material comprises an alloy comprising silicon (also referred to as “Si alloy” or “silicon alloy”). The alloy comprising silicon may be an alloy of silicon and a metal other than silicon (non-silicon metal), in which silicon and non-silicon metal are forming metallic bond. For example, an alloy of silicon and at least one selected from the group consisting of Li, B, Al, Ti, Fe, Pb, Sn, In, Bi, Ag, Ba, Ca, Hg, Pd, Pt, Te, Zn, La, Ni, P and N is preferable and an alloy of silicon and at least one selected from the group consisting of Li, B, Al, P, N, Ti, Fe and Ni is more preferable, and an alloy of silicon and at least one selected from the group consisting of B, Al, P and Ti is further preferable. The content of non-silicon metal in the alloy of silicon and a non-silicon metal is not particularly limited, but for example, it is preferably 0.1 to 5 mass %. Examples of the method for producing the alloy of silicon and a non-silicon metal include a method of mixing and melting elemental silicon and a non-silicon metal, and a method of coating the surface of elemental silicon with a non-silicon metal by vapor deposition or the like. Specifically examples of the method include a method of intentionally adding to Si a donor/acceptor forming element such as boron, nitrogen or phosphorus; a method of doping Si with Ti, Fe or the like; and a method of electrochemically reacting Si and lithium.

The Si alloy is preferably crystalline. When the Si alloy is crystalline, the discharge capacity can be increased. The fact that silicon is crystalline may be confirmed by powder XRD analysis. Even when silicon particles are present in the electrode, not in a powder state, crystallinity can be confirmed by electron beam diffraction analysis by irradiating an electron beam.

If the crystallinity of the silicon alloy particle is high, the active material capacity and charge and discharge efficiency tend to be increased. On the other hand, if the crystallinity thereof is low, the cycle characteristics of the lithium ion battery may be improved in some cases. However, the amorphous state may generate a plurality of crystal phases of the negative electrode in the charged state in some cases, and thus deviations in the negative electrode potential may become large in some cases. Crystallinity may be evaluated from calculation by Scherrer equation using FWHM (Full Width Half Maximum). The approximate crystallite size which results in being crystalline is, for example, preferably 50 nm or more and 500 nm or less, more preferably 70 nm or more and 200 nm or less.

The median diameter (D50 particle size) of the Si alloy is preferably 1.2 μm or less, more preferably 1 μm or less, further preferably 0.7 μm or less, still further preferably 0.6 μm or less, and still more further preferably 0.5 μm or less. The lower limit of the median diameter of the Si alloy is not particularly limited, but it is preferably 0.05 μm or more, more preferably 0.1 μm or more. When the median diameter of the Si alloy is 1.2 μm or less, volume expansion and contraction of each particle of the Si alloy during charge and discharge of the lithium ion secondary battery can be reduced, and deterioration due to non-uniformity such as crystal grain boundaries and defects hardly occurs. As a result, cycle characteristics such as capacity retention ratio of the lithium ion secondary battery are improved. If the median diameter of silicon is too large, grain boundaries and interfaces increase, and thus in addition to the increase of heterogeneous reaction in the particle, segregation of side reaction products and the like are observed more often. In the present invention, the median diameter (D50) is determined based on volume-based particle diameter distribution by laser diffraction/scattering type particle size distribution measurement.

The silicon alloy having a median diameter of 1.2 μm or less may be prepared by a chemical synthesis method or may be obtained by pulverizing a coarse silicon compound (for example, silicon having the size of about 10 to 100 μm). The pulverization can be carried out by a conventional method, for example, using a conventional pulverizing machine such as a ball mill and a hammer mill or pulverizing means.

The negative electrode of the present example embodiment preferably comprises a silicon alloy having a median diameter of 1.2 μm or less. Herein, such silicon alloy is also referred to as “Si alloy (a)”. When the negative electrode comprises the Si alloy (a), a lithium ion secondary battery having high capacity and excellent cycle characteristics can be formed. The Si alloy (a) is preferably crystalline.

The specific surface area (CS) of the Si alloy (a) is not particularly limited, but it is preferably 1 m²/cm³ or more, more preferably 5 m²/cm³ or more, further preferably 10 m²/cm³ or more. The specific surface area (CS) of the Si alloy (a) is preferably 300 m²/cm³ or less. Herein, CS (Calculated Specific Surfaces Area) means a specific surface area (unit: m²/cm³) assuming that particles are spheres.

The Si alloy (a) easily forms an oxide film on its surface. Thus, the surface may be partially or entirely covered with silicon oxide having a thickness of about several nm.

In the present example embodiment, the Si alloy (a) may be used in one type alone, or in two or more types in combination.

The amount of the Si alloy (a) based on the total weight of the negative electrode active material is preferably 65% by weight or more, more preferably 80% by weight or more, further preferably 90% by weight or more, still more preferably 93% by weight or more, and may be 100% by weight. When the amount of the Si alloy (a) is 65% by weight or more, a high negative electrode capacity can be obtained. When the amount of the silicon alloy having a small median diameter is large, aggregation of the silicon alloy easily occurs and a part of silicon alloys may not contribute to charge and discharge. On the other hand, since a silicon alloy having a large median diameter undergoes a large volume change due to the absorption and desorption of lithium, a problem that the charge and discharge cycle characteristics are deteriorated easily causes. The inventors of the present invention have conducted extensive studies to solve these problems, and found that when a Si alloy having a small particle size with a median diameter of 1.2 μm or less is used and a negative electrode binder content is 12% by weight or more, a secondary battery having excellent cycle characteristics can be obtained even if the amount of the silicon alloy is large.

The negative electrode active material may comprise graphite in addition to the Si alloy (a). The type of the graphite in the negative electrode active material is not particularly limited, but examples thereof may include natural graphite and artificial graphite, and may include two or more types among them. The shape of the graphite may be, for example, spherical, massive or the like. Graphite has high electrical conductivity and is excellent in adhesion to a current collector made of metal and in flatness of voltage. If graphite is included, the influence of the expansion and contraction of the Si alloy during charge and discharge of the lithium ion secondary battery may be reduced and the cycle characteristics of the lithium ion secondary battery can be improved.

The median diameter (D50) of the graphite is not particularly limited, but is preferably 1 μm or more, more preferably 3 μm or more, further preferably 5 μm or more, and preferably 20 μm or less, more preferably 15 μm or less.

The specific surface area of the graphite is not particularly limited, but, for example, the BET specific surface area thereof is preferably 0.5 to 9 m²/g, and more preferably 0.8 to 5 m²/g.

The crystalline structure of the graphite is not particularly limited as long as it is capable of absorbing and desorbing lithium ions. For example, a plane gap d (002) may be preferably about 0.3354 to 0.34 nm, more preferably about 0.3354 to 0.338 nm.

The amount of graphite based on the total weight of the negative electrode active material is not particularly limited and may be 0% by weight, but is preferably 0.5% by weight or more, more preferably 0.8% by weight or more, and the upper limit is preferably 35% by weight or less, more preferably 25% by weight or less, still more preferably 10% by weight or less.

The negative electrode active material may comprise other negative electrode active materials other than the above materials as long as the effects of the present invention can be achieved. The other negative electrode active materials may include, for example, a material comprising silicon as a constituent element (except for a silicon alloy having a median diameter of 1.2 μm or less; hereinafter, also referred to as “silicon materials”). Examples of the silicon materials include a metal silicon (elemental silicon) and a silicon oxide represented by the formula: SiOₓ(0<x≤2). The median diameter of the silicon materials is not particularly limited, but is preferably 0.1 μm or more and 10 μm or less, more preferably 0.2 μm or more and 8 μm or less.

The silicon materials may preferably comprise a silicon oxide. When the silicon materials comprises a silicon oxide, localized stress concentration in the negative electrode can be reduced as disclosed in for example, Japanese Patent No. 3982230. The amount of the silicon oxide based on the total weight of the negative electrode active material may be about several ppm, but is preferably 0.2% by weight or more, and preferably 5% by weight or less, more preferably 3% by weight or less, and may be 0% by weight. The median diameter of the silicon oxide is not particularly limited, but is preferably, for example, about 0.5 to 9 μm. If the particle size is too small, the reactivity with the electrolyte solution or the like increases, resulting in that the life characteristics may decrease in some cases. If the particle size is too large, the expansion and contraction during absorbing and desorbing Li becomes large, and cracking of the particles easily occurs, resulting in that the life may be shortened.

Other negative electrode active materials may comprise a silicon alloy other than the Si alloy (a), that is, may comprise a silicon alloy having a median diameter of more than 1.2 μm or an amorphous silicon alloy as long as the effects of the present invention can be achieved. The amount of these in the negative electrode active material is preferably 5% by weight or less, more preferably 3% by weight or less, and may be 0% by weight.

Other negative electrode active materials may comprise a carbon material other than graphite as long as the effects of the present invention are not impaired. Examples of the carbon material include amorphous carbon, graphene, diamond-like carbon, carbon nanotube and a composite thereof. When amorphous carbon, which has low crystallinity, is relatively low in volume expansion, it is highly effective to reduce volume expansion of the entire negative electrode, and in addition, deterioration due to non-uniformity such as crystal grain boundary and defect hardly occurs. The amount of these in total of the negative electrode active material is preferably 5% by weight or less, and may be 0% by weight.

Examples of other negative electrode active materials also include metals other than silicon and metal oxides. Examples of the metal include Li, Al, Ti, Pb, Sn, In, Bi, Ag, Ba, Ca, Hg, Pd, Pt, Te, Zn, La, and alloys of two or more of these. These metals or alloys may comprise one or more non-metallic elements. Examples of the metal oxide include aluminum oxide, tin oxide, indium oxide, zinc oxide, lithium oxide, a composite thereof or the like. One or two or more element(s) selected from nitrogen, boron and sulfur may be added to the metal oxide, for example, in an amount of 0.1 to 5 mass %. This may improve the electrical conductivity of the metal oxide in some cases.

The amount of the negative electrode active material in the negative electrode mixture layer is preferably 45% by weight or more, more preferably 50% by weight or more, still more preferably 55% by weight or more, and preferably 88% by weight or less, more preferably 80% or less.

The negative electrode active material may comprise one type alone or two or more types.

### (Negative Electrode Binder)

The negative electrode binder is not particularly limited, but for example, polyacrylic acid (also described as “PAA”), styrene-butadiene rubber (SBR), polyvinylidene fluoride, vinylidene fluoride-hexafluoropropylene copolymer, vinylidene fluoride-tetrafluoroethylene copolymer, polytetrafluoroethylene, polypropylene, polyethylene, polyimide, polyamideimide, polystyrene, polyacrylonitrile and the like may be used. One type thereof may be used alone or two or more types thereof may be used in combination. A thickener such as carboxymethyl cellulose (CMC) may also be used in combination. Among these, from the viewpoint of excellent binding properties, it is preferable to comprise SBR, a combination of SBR and CMC, or a polyacrylic acid, and more preferably comprise a polyacrylic acid.

The amount of the negative electrode binder based on the total weight of the negative electrode mixture layer is preferably 12% by weight or more, more preferably 15% by weight or more, still more preferably 20% by weight or more, further preferably 25% by weight or more, still more further preferably 30% by weight or more, and preferably 50% by weight or less, and more preferably 45% by weight or less. In one aspect of the present example embodiment, the Si alloy (a) having a median diameter of 1.2 μm or less is used as the negative electrode active material. If the amount of the Si alloy (a) having a small particle size is large (for example, the amount of the Si alloy in the negative electrode active material is 65% by weight or more), the problem that powder falling increases and cycle characteristics of the secondary battery easily deteriorate usually occurs. However, when the amount of the negative electrode binder is 12% by weight or more and preferably 15% by weight or more based on the total weight of the negative electrode mixture layer, powder falling of the Si alloy can be suppressed, so that deterioration in cycle characteristics of the secondary battery can be suppressed. On the other hand, when the amount of the negative electrode binder is 50% by weight or less, a decrease in energy density of the negative electrode can be suppressed.

Hereinafter, as one preferable aspect of the present example embodiment, polyacrylic acid (PAA) as a negative electrode binder will be described in detail, but the present invention is not limited thereto.

The polyacrylic acid comprises a (meth)acrylic acid monomer unit represented by the following formula (11). In the present specification, the term “(meth)acrylic acid” means acrylic acid and methacrylic acid.

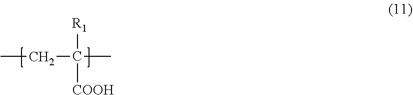

wherein in formula (11), R₁ is a hydrogen atom or a methyl group.

The carboxylic acid in the monomer unit represented by the formula (11) may be a carboxylic acid salt such as a metal salt of a carboxylic acid. The metal is preferably a monovalent metal. Examples of the monovalent metal include alkali metals (for example, Na, Li, K, Rb, Cs, Fr and the like) and noble metals (for example, Ag, Au, Cu and the like), and Na and K are preferred, and Na is more preferred. When the polyacrylic acid comprises a carboxylic acid salt in at least a part of the monomer units, the adhesion to the constituent material of the electrode mixture layer may be further improved in some cases.

The polyacrylic acid may comprise other monomer units. When the polyacrylic acid further comprises monomer units other than the (meth)acrylic acid monomer unit, the peel strength between the electrode mixture layer and the current collector may be improved in some cases. As other monomer units, monomer units derived from monomers including ethylenically unsaturated carboxylic acids including monocarboxylic acid compounds such as crotonic acid and pentenoic acid, dicarboxylic acid compounds such as itaconic acid and maleic acid, sulfonic acid compounds such as vinyl sulfonic acid, and phosphonic acid compounds such as vinyl phosphonic acid; aromatic olefins having acidic groups such as styrene sulfonic acid and styrene carboxylic acid; (meth)acrylic acid alkyl esters; acrylonitrile; aliphatic olefins such as ethylene, propylene and butadiene; aromatic olefins such as styrene may be exemplified. Other monomer unit(s) may be a monomer unit constituting a known polymer used as a binder for a secondary battery. In these monomer units, if present, the acids may be also replaced with their salts.

Furthermore, in the polyacrylic acid, at least one hydrogen atom in the main chain and side chain may be substituted with halogen (fluorine, chlorine, boron, iodine and the like).

When the polyacrylic acid is a copolymer comprising two or more kinds of monomer units, the copolymers may be a random copolymer, an alternating copolymer, a block copolymer, a graft copolymer and the like, or combinations thereof.

The molecular weight of the polyacrylic acid is not particularly limited, but the weight-average molecular weight is preferably 1000 or more, more preferably in the range of 10,000 to 5,000,000, and particularly preferably in the range of 300,000 to 350,000. When the weight-average molecular weight is within the above range, good dispersibility of the active material and the conductive assistant agent can be maintained and excessive increase in slurry viscosity can be suppressed.

In general, an active material having a large specific surface area requires a large amount of a binder, but the polyacrylic acid has high binding ability even in a small amount. Therefore, when the polyacrylic acid is used as the negative electrode binder, the increase in resistance due to the binder is small even for the electrode comprising an active material having a large specific surface area.

Since the specific surface area of the negative electrode of the present example embodiment is increased by comprising a negative electrode active material of a Si alloy having a small particle size, it is preferable to use polyacrylic acid as the negative electrode binder. In addition, the binder comprising the polyacrylic acid is excellent in reducing the irreversible capacity of the battery, increasing the capacity of the battery and improving the cycle characteristics.

For the purpose of reducing the impedance, the negative electrode may additionally comprise an electrically conductive assistant agent. Examples of the electrically conductive assistant agent include flake-like or fibrous carbonaceous fine particles, for example, carbon black, acetylene black, Ketjen black, fibrous carbon such as vapor grown carbon fiber, and the like. The amount of the electrically conductive assistant agent in the negative electrode mixture layer may be 0% by weight, but is preferably, for example, 0.5 to 5% by weight.

As the negative electrode current collector, aluminum, nickel, stainless steel, chromium, copper, silver, iron, manganese, molybdenum, titanium, niobium and alloys thereof are preferred from the viewpoint of electrochemical stability. Examples of its shape include foil, a flat plate shape, and a mesh shape. Among these, stainless steel foil, electrolytic copper foil, and high-strength current collector foil such as rolled copper foil and clad current collector foil are particularly preferable. The clad current collector foil preferably contains copper.

In the present example embodiment, the capacity per mass of the negative electrode mixture layer (initial lithium storage amount at 0 V to 1 V when lithium metal is used as a counter electrode) is preferably 1500 mAh/g or more, and, but is not particularly limited to, preferably 4200 mAg/or less. In this specification, the capacity of the negative electrode mixture layer is calculated based on the theoretical capacity of the negative electrode active material.

The density of the negative electrode mixture layer of the negative electrode of the present example embodiment is not particularly limited, but is preferably 0.4 g/cm³ or more, and is preferably less than 1.35 g/cm³. When the density of the negative electrode mixture layer is within the above range, a lithium ion secondary battery having high energy density and excellent cycle characteristics can be obtained. There is a case where the step of compression molding by roll pressing or the like is not required in the process of manufacturing the negative electrode to make the density of the negative electrode mixture layer of the negative electrode within the above range, and in this case, the manufacturing cost of the negative electrode may be reduced.

The negative electrode may be produced according to a usual method. In one embodiment, first, a negative electrode active material, a negative electrode binder, and an optional component such as an electrically conductive assistant agent are mixed in a solvent to prepare a slurry. Preferably, in each step, slurry is prepared by mixing by a V-type mixer (V blender), mechanical milling, or the like in a stepwise manner. Subsequently, the prepared slurry is applied to a negative electrode current collector and dried to prepare a negative electrode in which a negative electrode mixture layer is formed on the negative electrode current collector, and then, if necessary, compression molding is performed by a roll press or the like. Applying may be carried out by a doctor blade method, a die coater method, a reverse coater method, or the like.

### <Positive Electrode>

Hereinafter, a positive electrode will be described, wherein the positive electrode that serves as a counter electrode when an electrode comprising a Si alloy is used as a negative electrode of a lithium ion secondary battery. The positive electrode may have a structure in which a positive electrode mixture layer comprising a positive electrode active material is formed on a positive electrode current collector. A positive electrode of the present example embodiment comprises, for example, a positive electrode current collector formed of a metal foil and a positive electrode mixture layer formed on one surface or both surfaces of the positive electrode current collector. The positive electrode mixture layer is formed so as to cover the positive electrode current collector with a positive electrode binder. The positive electrode current collector is arranged to have an extended portion connected to a positive electrode terminal, and the positive electrode mixture layer is not formed on the extended portion. Here, in the present specification, the “positive electrode mixture layer” refers to a portion of the members constituting the positive electrode excluding the positive electrode current collector, and comprises a positive electrode active material and a positive electrode binder, and if necessary, may comprise an additive such as a electrically conductive assistant agent and the like. The positive electrode active material is a material capable of absorbing and desorbing lithium. In this specification, a substance that does not absorb and desorb lithium, such as a binder, is not included in the positive electrode active material.

The positive electrode active material is not particularly limited as long as the material can absorb and desorb lithium, and may be selected from several viewpoints. From the viewpoint of achieving higher energy density a high capacity compound is preferably contained. Examples of the high capacity compound include Li-rich layered positive electrode, lithium nickelate (LiNiO₂), and a lithium nickel composite oxide in which a part of the Ni of lithium nickelate is replaced by another metal element, and a Li-rich layered positive electrode represented by the following formula (A1) and a layered lithium nickel composite oxide represented by the following formula (A2) are preferred.

Li(LiₓM_{1-x-z}Mn_{z})O₂ (A1)

wherein in formula (A1), 0.1≤x≤0.3, 0.4≤z≤0.8, M is at least one of Ni, Co, Fe, Ti, Al, and Mg;

Li_{y}Ni₍₁₋ₓ₎MₓO₂ (A2)

wherein in formula (A2), 0≤x≤1, 0≤y≤1, M is at least one element selected from the group consisting of Li, Co, Al, Mn, Fe, Ti, and B.

From the viewpoint of high capacity, it is preferred that the content of Ni is high, that is, x is less than 0.5, further preferably 0.4 or less in the formula (A2). Examples of such compounds include Li_{α}Ni_{β}Co_{γ}Mn_{δ}O₂ (0≤α≤1.2, preferably 1≤α≤1.2, α+β+γ+δ=2, β≥0.7, and γ≤0.2) and Li_{α}Ni_{β}Co_{γ}Al_{δ}O₂ (0<α≤1.2, preferably 1≤α≤1.2, α+β+γ+δ=2, β≥0.6, preferably β≥0.7, and γ≤0.2) and particularly include LiNi_{β}Co_{γ}Mn_{δ}O₂ (0.75≤β≤0.85, 0.05≤γ≤0.15, and 0.10≤δ≤0.20, β+γ+δ=1). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, and LiNi_{0.8}Co_{0.1}Al_{0.1}O₂ may be preferably used.

From the viewpoint of thermal stability, it is also preferred that the content of Ni does not exceed 0.5, that is, x is 0.5 or more in the formula (A2). In addition, it is also preferred that particular transition metals do not exceed half. Examples of such compounds include Li_{α}Ni_{β}Co_{γ}Mn_{δ}O₂ (0≤α≤1.2, preferably 1≤α≤1.2, α+β+γ+δ=2, 0.2≤β≤0.5, 0.1≤γ≤0.4, and 0.1≤δ≤0.4). More specific examples may include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532) (also including those in which the content of each transition metal fluctuates by about 10% in these compounds).

In addition, two or more compounds represented by the formula (A2) may be mixed and used, and, for example, it is also preferred that NCM532 or NCM523 and NCM433 are mixed in the range of 9:1 to 1:9 (as a typical example, 2:1) and used. Further, by mixing a material in which the content of Ni in formula (A2) is high (x is 0.4 or less) and a material in which the content of Ni in formula (A2) does not exceed 0.5 (x is 0.5 or more, for example, NCM433), a battery having high capacity and high thermal stability can also be formed.

As the positive electrode active material other than the above, for example, lithium manganates having a layered structure or a spinel structure, such as LiMnO₂, LixMn₂O₄ (0<x<2), Li₂MnO₃, and LiₓMn_{1.5}Ni_{0.5}O₄ (0<x<2); LiCoO₂, or materials in which a part of such transition metals is substituted with other metal(s); materials having Li in an excessive amount as compared with the stoichiometric composition in these lithium transition metal oxides; and materials having an olivine structure such as LiFePO₄ may be exemplified. Further, materials obtained by substituting a part of these metal oxides with Al, Fe, P, Ti, Si, Pb, Sn, In, Bi, Ag, Ba, Ca, Hg, Pd, Pt, Te, Zn, La, or the like may also be used. Such positive electrode active materials described above may be used alone, or in combination of two or more thereof.

Examples of a positive electrode binder include, but are not limited to, polyvinylidene fluoride, vinylidene fluoride-hexafluoropropylene copolymer, vinylidene fluoride-tetrafluoroethylene copolymer, polytetrafluoroethylene, polypropylene, polyethylene, polyimide, polyamideimide, polyacrylic acid and the like. Styrene-butadiene rubber (SBR) or the like may be used. When an aqueous binder such as an SBR emulsion is used, a thickener such as carboxymethyl cellulose (CMC) may also be used. The positive electrode binder may be used by mixing two or more kinds. From the viewpoint of a trade-off relationship between “sufficient binding force” and “high energy density”, the amount of the positive electrode binder is preferably 2 to 10 parts by mass based on 100 parts by mass of the positive electrode active material.

To the coating layer comprising the positive electrode active material, an electrically conductive assistant agent may be added for the purpose of reducing the impedance. Examples of the electrically conductive assistant agent include flake-like or fibrous carbonaceous fine particles, such as graphite, carbon black, acetylene black and fibrous carbon such as vapor grown carbon fiber.

As the positive electrode current collector, from the viewpoint of electrochemical stability, aluminum, nickel, copper, silver, iron, chromium, manganese, molybdenum, titanium, niobium, and alloys thereof are preferable. Examples of its shape include foil, a flat-plate shape, and a mesh shape. In particular, a current collector using aluminum, an aluminum alloy, or iron-nickel-chromium-molybdenum-based stainless steel is preferable.

The positive electrode may be prepared by forming the positive electrode mixture layer comprising the positive electrode active material and the positive electrode binder on the positive electrode current collector. Examples of a method of forming the positive electrode mixture layer include a doctor blade method, a die coater method, a CVD method, a sputtering method, and the like. It is also possible that after forming the positive electrode mixture layer in advance, a thin film of aluminum, nickel or an alloy thereof as a positive electrode current collector is formed thereon by a method such as vapor deposition or sputtering.

In the present example embodiment, it may be preferred in some cases that the capacity ratio represented by (capacity per unit area of the negative electrode/capacity per unit area of the positive electrode) in the configuration of the negative electrode and the positive electrode that are arranged to face each other via the separator is preferably more than 1:1 and preferably 2 or less. When the capacity ratio is within the above range, a secondary battery excellent in cycle characteristics can be obtained.

### <Electrolyte Solution>

As the electrolyte solution (non-aqueous electrolyte solution), for example, a solution in which a supporting salt is dissolved in a non-aqueous solvent may be used.

The electrolyte solution used in the present example embodiment preferably comprises, as a non-aqueous solvent, 60% by volume or more and 99% by volume or less of a phosphoric acid ester compound, 0% by volume or more and 30% by volume or less of a fluorinated ether compound, and 1% by volume or more and 35% by volume or less of a fluorinated carbonate compound, wherein the total amount of the phosphoric acid ester compound and the fluorinated ether compound is 65% by volume or more. Such electrolyte solution is excellent in self-extinguishing property and can improve the capacity retention ratio of the secondary battery.

Examples of the phosphoric acid ester compound include a compound represented by the following formula (1):

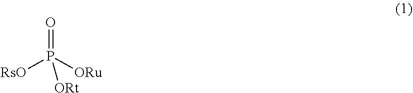

In formula (1), Rs, Rt and Ru are each independently an alkyl group, a halogenated alkyl group, an alkenyl group, a halogenated alkenyl group, an aryl group, a cycloalkyl group, a halogenated cycloalkyl group or a silyl group, and any two or all of Rs, Rt and Ru may be bonded to form a cyclic structure. The alkyl group, halogenated alkyl group, alkenyl group, halogenated alkenyl group, aryl group, cycloalkyl group and halogenated cycloalkyl group preferably have 10 or less carbon atoms. Examples of the halogen atom contained in the halogenated alkyl group, the halogenated alkenyl group and the halogenated cycloalkyl group include fluorine, chlorine, bromine and iodine. It is preferable that each of Rs, Rt and Ru is an alkyl group having 10 or less carbon atoms.

Specific examples of the phosphoric acid ester compound include alkyl phosphate ester compounds such as trimethyl phosphate, triethyl phosphate, tripropyl phosphate, tributyl phosphate, tripentyl phosphate, trihexyl phosphate, triheptyl phosphate, trioctyl phosphate, dimethyl ethyl phosphate, and diethyl methyl phosphate; aryl phosphate ester compounds such as triphenyl phosphate; phosphate ester compounds having a cyclic structure, such as methyl ethylene phosphate, ethyl ethylene phosphate (EEP), and ethyl butylene phosphate; and halogenated alkyl phosphate ester compounds such as tris(trifluoromethyl)phosphate, tris(pentafluoroethyl)phosphate, tris(2,2,2-trifluoroethyl)phosphate, tris(2,2,3,3-tetrafluoropropyl)phosphate, tris(3,3,3-trifluoropropyl)phosphate, and tris(2,2,3,3,3-pentafluoropropyl)phosphate. Among them, as the phosphoric acid ester compound, a trialkyl phosphate ester compound such as trimethyl phosphate, triethyl phosphate, tripropyl phosphate, tributyl phosphate, tripentyl phosphate, trihexyl phosphate, triheptyl phosphate, or trioctyl phosphate is preferably used.

In one aspect of the present example embodiment, when the phosphoric acid ester compound has too many fluorine atoms, it may be difficult to dissolve the lithium salt used as the supporting salt. Therefore, it is preferable to use a phosphoric acid ester compound having no fluorine.

The phosphoric acid ester compounds can be used alone or in combination of two or more.

The fluorinated carbonate compound may be a fluorinated cyclic carbonate compound or a fluorinated open-chain carbonate compound. The fluorinated carbonate compounds may be used alone or in combination of two or more.

Examples of the fluorinated cyclic carbonate compound include the compound represented the following formula (2a) or (2b):

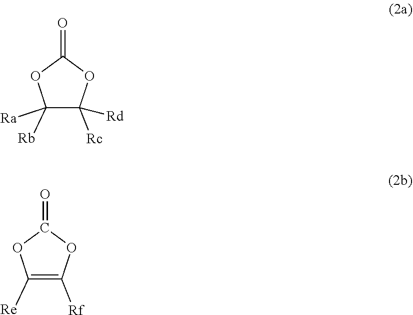

In formula (2a) and (2b), Ra, Rb, Rc, Rd, Re and Rf are each independently a hydrogen atom, an alkyl group, a halogenated alkyl group, a halogen atom, an alkenyl group, a halogenated alkenyl group, a cyano group, an amino group, a nitro group, an alkoxy group, a halogenated alkoxy group, a cycloalkyl group, a halogenated cycloalkyl group or a silyl group, wherein at least one of Ra, Rb, Rc and Rd is a fluorine atom, a fluorinated alkyl group, a fluorinated alkenyl group, a fluorinated alkoxy group or a fluorinated cycloalkyl group, and at least one of Re and Rf is a fluorine atom, a fluorinated alkyl group, a fluorinated alkenyl group, a fluorinated alkoxy group or a fluorinated cycloalkyl group. The alkyl group, halogenated alkyl group, alkenyl group, halogenated alkenyl group, alkoxy group, halogenated alkoxy group, cycloalkyl group and halogenated cycloalkyl group have preferably 10 or less carbon atoms, and more preferably 5 or less carbon atoms. Examples of the halogen atom in the halogenated alkyl group, halogenated alkenyl group, halogenated alkoxy group and halogenated cycloalkyl group include fluorine, chlorine, bromine and iodine.

As the fluorinated cyclic carbonate compound, a compound obtained by fluorinating all or part of ethylene carbonate, propylene carbonate, vinylene carbonate or vinyl ethylene carbonate may be used. Among them, it is preferable to use a compound obtained by partially fluorinating ethylene carbonate such as fluoroethylene carbonate, cis- or trans-difluoroethylene carbonate, and it is preferable to use fluoroethylene carbonate.

Examples of the fluorinated open-chain carbonate compound include the compound represented by the following formula (3):

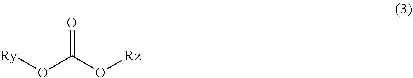

In formula (3), Ry and Rz are each independently a hydrogen atom, an alkyl group, a halogenated alkyl group, a halogen atom, an alkenyl group, a halogenated alkenyl group, a cyano group, an amino group, a nitro group, an alkoxy group, a halogenated alkoxy group, a cycloalkyl group, a halogenated cycloalkyl group or a silyl group, wherein at least one of Ry and Rz is a fluorine atom, a fluorinated alkyl group, a fluorinated alkenyl group, a fluorinated alkoxy group, or a fluorinated cycloalkyl group. The alkyl group, halogenated alkyl group, alkenyl group, halogenated alkenyl group, alkoxy group, halogenated alkoxy group, cycloalkyl group and halogenated cycloalkyl group have preferably 10 or less carbon atoms, and more preferably 5 or less carbon atoms. Examples of the halogen atom in the halogenated alkyl group, halogenated alkenyl group, halogenated alkoxy group and halogenated cycloalkyl group include fluorine, chlorine, bromine and iodine.

Specific examples of the fluorinated open-chain carbonate compound include bis(1-fluoroethyl) carbonate, bis(2-fluoroethyl) carbonate, 3-fluoropropyl methyl carbonate and 3,3,3-trifluoropropyl methyl carbonate.

The fluorinated carbonate compounds may be used alone or in combination of two or more.

The fluorinated ether compound is preferably an open-chain fluorinated ether compound. The open-chain fluorinated ether compound is preferably the compound represented by the following formula (4-1):

Ra-O-Rb (4-1)

wherein in formula (4-1), Ra and Rb each independently represent an alkyl group or a fluorine-substituted alkyl group, and at least one of Ra and Rb is a fluorine-substituted alkyl group;

more preferably the compound represented by the following formula (4-2):

H—(CX¹X²—CX³X⁴)ₙ—CH₂O—CX⁵X⁶—CX⁷X⁸—H (4-2)

wherein in formula (4-2), n is 1, 2, 3 or 4; X¹ to X⁸ are each independently a fluorine atom or a hydrogen atom, and at least one of X¹ to X⁴ is a fluorine atom and at least one of X⁵ to X⁸ is a fluorine atom; in addition, the atomic ratio of fluorine atoms and the hydrogen atoms bound to a compound of formula (4-2) satisfies [(total number of fluorine atoms)/(total number of hydrogen atoms)]≥1; and

further preferably the compound represented by the following formula (4-3):

H—(CF₂—CF₂)ₙ—CH₂O—CF₂—CF₂—H (4-3)

wherein in formula (4-3), n is 1 or 2.

Examples of the fluorinated ether compound include 2,2,3,3,3-pentafluoropropyl 1,1,2,2-tetrafluoroethyl ether, 1,1,2,2-tetrafluoroethyl 2,2,2-trifluoroethyl ether, 1H, 1H, 2′H, 3H-decafluorodipropyl ether, 1,1,2,3,3,3-hexafluoropropyl 2,2-difluoroethyl ether, isopropyl 1,1,2,2-tetrafluoroethyl ether, propyl 1,1,2,2-tetrafluoroethyl ether, 1,1,2,2-tetrafluoroethyl 2,2,3,3-tetrafluoropropyl ether, 1H, 1H, 5H-perfluoropentyl 1,1,2,2-tetrafluoroethyl ether, 1H-perfluorobutyl 1H-perfluoroethyl ether, methyl perfluoropentyl ether, methyl perfluorohexyl ether, methyl 1,1,3,3,3-pentafluoro-2-(trifluoromethyl)propyl ether, 1,1,2,3, 3,3-hexafluoropropyl 2,2,2-trifluoroethyl ether, ethyl nonafluorobutyl ether, ethyl 1,1,2,3,3,3-hexafluoropropyl ether, 1H, 1H, 5H-octafluoropentyl 1,1,2,2-tetrafluoroethyl ether, 1H, 1H, 2′H-perfluorodipropyl ether, heptafluoropropyl 1,2,2,2-tetrafluoroethyl ether, 2,2,3,3,3-pentafluoropropyl 1,1,2,2-tetrafluoroethyl ether, ethyl nonafluorobutyl ether, methyl nonafluorobutyl ether, 1,1-difluoroethyl 2,2,3,3-tetrafluoropropyl ether, bis(2,2,3,3-tetrafluoropropyl) ether, 1,1-difluoroethyl 2,2,3,3,3-pentafluoropropyl ether, 1,1-difluoroethyl 1H, 1H-heptafluorobutyl ether, 2,2,3,4,4,4-hexafluorobutyl difluoromethyl ether, bis(2,2,3,3,3-pentafluoropropyl) ether, nonafluorobutyl methyl ether, bis(1H, 1H-heptafluorobutyl) ether, 1,1,2,3,3,3-hexafluoropropyl 1H, 1H-heptafluorobutyl ether, 1H, 1H-heptafluorobutyl trifluoromethyl ether, 2,2-difluoroethyl 1,1,2,2-tetrafluoroethyl ether, bis(trifluoroethyl) ether, bis(2,2-difluoroethyl) ether, bis(1,1,2-trifluoroethyl) ether, 1,1,2-trifluoroethyl 2,2,2-trifluoroethyl ether, bis(2,2,3,3-tetrafluoropropyl) ether and the like.

The fluorinated ether compounds may be used alone or in combination of two or more.

In the present example embodiment, the amount of the phosphoric acid ester compound in the electrolyte solution is preferably 60% by volume or more, more preferably 65% by volume or more, further preferably 70% by volume or more, and the upper limit is preferably 99% by volume or less, more preferably 95% by volume or less, and further preferably 90% by volume or less. Inclusion of the phosphoric acid ester improves the self-extinguishing property of the electrolyte solution. If the amount of the phosphoric acid ester is too small, an electrolyte solution with excellent self-extinguishing property may not be obtained, and if the amount of the phosphoric acid ester is too large, the capacity retention ratio of the secondary battery may be decreased in some cases.

The amount of the fluorinated carbonate in the electrolyte solution is preferably 1% by volume or more, more preferably 2% by volume or more, further preferably 5% by volume or more, still more further preferably 8% by volume or more, and the upper limit is preferably 35% by volume or less, more preferably 30% by volume or less, further preferably 25% by volume or less, and still more further preferably 15% by volume or less. Inclusion of the fluorinated carbonate compound improves the cycle characteristics of the secondary battery. It is inferred that inclusion of the fluorinated carbonate compound generates HF (hydrogen fluoride), which dissolves the surface of the Si alloy and effects initiation of charging and discharging.

The amount of the fluorinated ether compound in the electrolyte solution may be 0% by volume, but is preferably 5% by volume or more, more preferably 8% by volume or more, still more preferably 10% by volume or more, and the upper limit is preferably 30% by volume or less, more preferably 25% by volume or less. Inclusion of the fluorinated ether in the electrolyte solution can attain an electrolyte solution excellent in self-extinguishing property. However, if the amount of the fluorinated ether is too large, the electrolyte solution solvent may be non-uniform because the compatibility of the fluorinated ether is poor.

The total amount of the phosphoric acid ester compound and the fluorinated ether compound in the electrolyte solution is preferably 65% by volume or more, more preferably 70% by volume or more, further preferably 80% by volume or more, still more preferably 90% by volume or more, and the upper limit is preferably 99% by volume or less, more preferably 95% by volume or less. When the total amount of the phosphoric acid ester compound and the fluorinated ether compound is 65% by volume or more, the electrolyte solutionexcellent in self-extinguishing property can be obtained, and when the total amount is 99% by volume or less, the secondary battery excellent in capacity retention ratio can be constituted.

As one aspect of the present example embodiment, it is preferable that the total amount of the phosphoric acid ester compound and the fluorinated ether compound in the electrolyte solution is 90 to 95% by volume and the amount of the fluorinated carbonate compound is 5 to 10% by volume. The volume ratio of “the amount of the phosphoric acid ester compound: the amount of the fluorinated ether compound” is not particularly limited, but for example, 1:1 to 10:1 is preferable, 1:1 to 8:1 is more preferable, and it may be 1:1 to 2:1.

The electrolyte solution used in the present example embodiment may comprise other organic solvent. Examples of other organic solvents include carbonates such as ethylene carbonate (EC), propylene carbonate (PC), butylene carbonate (BC), vinylene carbonate (VC), vinyl ethylene carbonate (VEC), dimethyl carbonate (DMC), ethyl methyl carbonate (EMC), chloroethylene carbonate, diethyl carbonate (DE); ethylene sulfite (ES), propane sultone (PS), butane sultone (BS), dioxathiolane-2,2-dioxide (DD), sulfolene, 3-methylsulfolene, sulfolane (SL), succinic anhydride (SUCAH), propionic anhydride, acetic anhydride, maleic anhydride, diallyl carbonate (DAC), diphenyl disulfide (DPS); ethers (excluding fluorinated ether compounds) such as dimethoxyethane (DME), dimethoxymethane (DMM), diethoxyethane (DEE), ethoxymethoxyethane, dimethyl ether, methyl ethyl ether, methyl propyl ether, ethyl propyl ether, dipropyl ether, methyl butyl ether, diethyl ether, phenyl methyl ether, tetrahydrofuran (THF), tetrahydropyran (THP), 1,4-dioxane (DIOX), 1,3-dioxolane (DOL); acetonitrile, propionitrile, γ-butyrolactone, γ-valerolactone, ionic liquids, phosphazene; and aliphatic carboxylic acid esters such as methyl formate, methyl acetate and ethyl propionate. Among them, ethylene carbonate, diethyl carbonate, propylene carbonate, dimethyl carbonate, ethylmethyl carbonate, γ-butyrolactone and γ-valerolactone are preferable. Other organic solvents may be used alone or in combination of two or more. The amount of other organic solvent in the electrolyte solution is preferably 30 vol % or less, more preferably 20 vol % or less, still more preferably 10 vol % or less, and may be 0 vol %.

The electrolyte solution used in the present example embodiment comprises a supporting salt. Specific examples of the supporting salt include lithium salt such as LiPF₆, LiI, LiBr, LiCl, LiAsF₆, LiAlCl₄, LiClO₄, LiBF₄, LiSbF₆, LiCF₃SO₃, LiC₄F₉SO₃, LiN(FSO₂)₂, LiN(CFSO₂)₂, LiN(C₂F₅SO₂)₂, LiN(CF₃SO₂)(C₂F₅SO₂), LiN(CF₃SO₂)(C₄F₉SO₂), LiN(CF₂SO₂)₂(CF₂) having a 5-membered ring structure, LiN(CF₂SO₂)₂(CF₂)₂ having a 6-membered ring structure, and the compound in which at least one fluorine atom in LiPF₆ is replaced with a fluoroalkyl group, such as LiPF₅(CF₃), LiPF₅(C₂F₅), LiPF₅(C₃F₇), LiPF₄(CF)₂, LiPF₄(CF)(C₂F₅) or LiPF₃(CF₃)₃. As the supporting salt, a compound represented by the following formula (21):

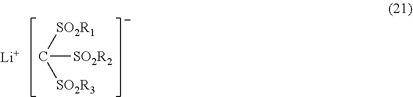

may be used. In formula (21), R₁, R₂, and R₃ are each independently a halogen atom or a fluorinated alkyl group. Examples of the halogen atom include fluorine, chlorine, bromine and iodine. The fluorinated alkyl group preferably has 1 to 10 carbon atoms. Specific examples of the compound represented by the formula (21) include LiC(CF₃SO₂)₃ and LiC(C₂F₅SO₂). The supporting salts may be used alone or in combination of two or more.

The concentration of the supporting salt in the electrolyte solution is preferably 0.01 M (mol/L) or more and 3 M (mol/L) or less, and more preferably 0.5 M (mol/L) or more and 1.5 M (mol/L) or less.

The electrolyte solution may further comprise other additives. Examples of other additives include, but not particularly limited to, unsaturated carboxylic acid anhydrides, unsaturated cyclic carbonates, and cyclic or open-chain monosulfonic acid esters, cyclic or open-chain disulfonic acid esters, and the like. Addition of these compounds may further improve the cycle characteristics of the battery in some cases. It is presumed that these additives are decomposed during charge and discharge of the lithium ion secondary battery to form a film on the surface of the electrode active material and suppress decompositions of the electrolyte solution and the supporting salt.

The amount of these additives in the electrolyte solution (the total amount thereof when the electrolyte solution comprises plural types) is not particularly limited, and may be 0% by weight, but is preferably 0.01% by weight or more and 10% by weight or less based on the total weight of the electrolyte solution. When the amount is 0.01% by weight or more, a sufficient film effect can be achieved. When the amount is 10% by weight or less, an increase in the viscosity of the electrolyte solution and an accompanying increase in resistance can be suppressed.

### [Separator]

The separator may be of any type as long as it suppresses electric conduction between the positive electrode and the negative electrode, does not inhibit the permeation of charged substances, and has durability against the electrolyte solution. Specific examples of the materials include polyolefins such as polypropylene and polyethylene; cellulose, polyethylene terephthalate, polyimide, polyvinylidene fluoride; and aromatic polyamides (aramid) such as polymetaphenylene isophthalamide, polyparaphenylene terephthalamide and copolyparaphenylene-3,4′-oxydiphenylene terephthalamide; and the like. These may be used as a porous film, a woven fabric, a nonwoven fabric and the like.

### [Insulation Layer]

An insulation layer may be formed on at least one surface of the positive electrode, the negative electrode and the separator. Examples of a method for forming the insulation layer include a doctor blade method, a dip coating method, a die coater method, a CVD method, a sputtering method and the like. The insulation layer may be formed at the same time as forming the positive electrode, the negative electrode, or the separator. Examples of materials constituting the insulation layer include a mixture of aluminum oxide, barium titanate or the like and SBR or PVDF (polyvinylidene fluoride).

### [Structure of Lithium Ion Secondary Battery]

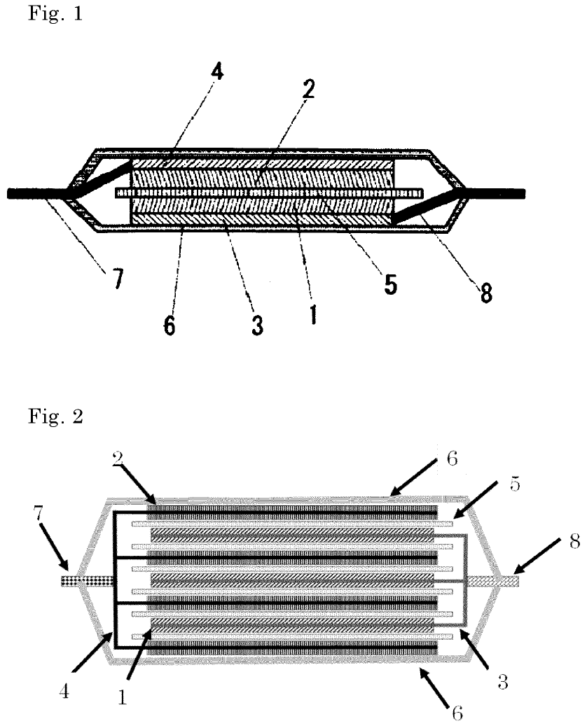

FIG. 1 shows a laminate-type secondary battery as an example of a secondary battery according to the present example embodiment. The separator 5 is sandwiched between a positive electrode comprising a positive electrode mixture layer 1 containing a positive electrode active material and a positive electrode current collector 3 and a negative electrode comprising a negative electrode mixture layer 2 and a negative electrode current collector 4. The positive electrode current collector 3 is connected to the positive electrode lead terminal 8 and the negative electrode current collector 4 is connected to the negative electrode lead terminal 7. The exterior laminate 6 is used for the outer package, and the interior of the secondary battery is filled with an electrolyte solution. The electrode element (also referred to as “battery element” or “electrode laminate”) preferably has a structure in which a plurality of positive electrodes and a plurality of negative electrodes are stacked via separators, as shown in FIG. 2.

Examples of the laminate resin film used in a laminate type include aluminum, aluminum alloy, titanium foil and the like. Examples of the material of the thermally bondable portion of the metal laminate resin film include thermoplastic polymer materials, such as polyethylene, polypropylene, and polyethylene terephthalate. In addition, each of the numbers of the metal laminate resin layers and the metal foil layers is not limited to one and may be two or more.

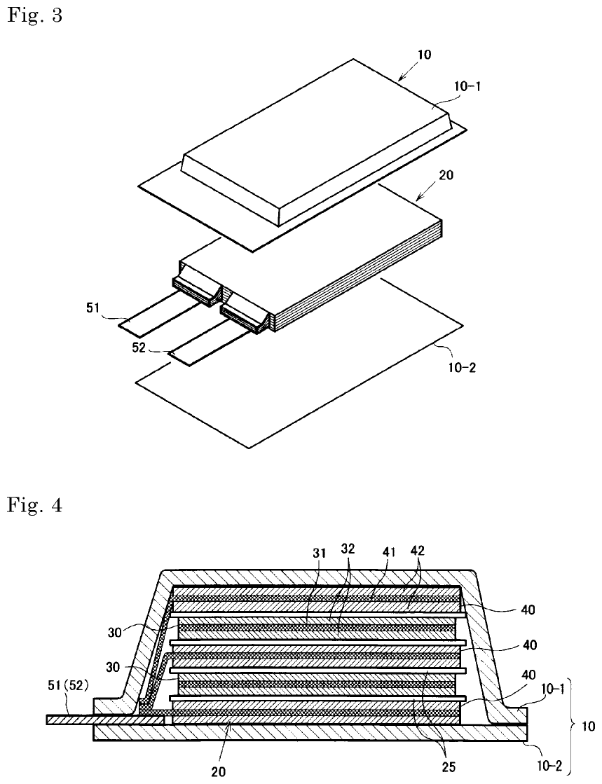

As another embodiment, a secondary battery having a structure as shown in FIG. 3 and FIG. 4 may be provided. This secondary battery comprises a battery element 20, a film package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 4. In the positive electrode 30, an electrode material 32 is applied to both surfaces of a metal foil 31, and also in the negative electrode 40, an electrode material 42 is applied to both surfaces of a metal foil 41 in the same manner. The present invention is not necessarily limited to stacking type batteries and may also be applied to batteries such as a winding type.

In the secondary battery in FIG. 1, the electrode tabs are drawn out on both sides of the package, but a secondary battery to which the present invention may be applied may have an arrangement in which the electrode tabs are drawn out on one side of the outer package as shown in FIG. 3. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 4). The portion in which the extended portions are brought together into one in the stacking direction in this manner is also referred to as a “current collecting portion” or the like.

The film package 10 is composed of two films 10-1 and 10-2 in this example. The films 10-1 and 10-2 are heat-sealed to each other in the peripheral portion of the battery element 20 and hermetically sealed. In FIG. 3, the positive electrode tab 51 and the negative electrode tab 52 are drawn out in the same direction from one short side of the film package 10 hermetically sealed in this manner.

Of course, the electrode tabs may be drawn out from different two sides respectively. In addition, regarding the arrangement of the films, in FIG. 3 and FIG. 4, an example in which a cup portion is formed in one film 10-1 and a cup portion is not formed in the other film 10-2 is shown, but other than this, an arrangement in which cup portions are formed in both films (not illustrated), an arrangement in which a cup portion is not formed in either film (not illustrated), and the like may also be adopted.

### [Method for Manufacturing Lithium Ion Secondary Battery]

The lithium ion secondary battery according to the present example embodiment can be manufactured according to a usual method. An example of a method for manufacturing a lithium ion secondary battery will be described taking a stacked laminate type lithium ion secondary battery as an example. First, in the dry air or an inert atmosphere, the positive electrode and the negative electrode are placed to oppose to each other via a separator to form the electrode element. Next, this electrode element is accommodated in an outer package (container), an electrolyte solution is injected, and the electrode is impregnated with the electrolyte solution. Thereafter, the opening of the outer package is sealed to complete the lithium ion secondary battery.

### [Assembled Battery]

A plurality of lithium ion secondary batteries according to the present example embodiment may be combined to form an assembled battery. The assembled battery may be configured by connecting two or more lithium ion secondary batteries according to the present example embodiment in series or in parallel or in combination of both. The connection in series and/or parallel makes it possible to adjust the capacitance and voltage freely. The number of lithium ion secondary batteries included in the assembled battery can be set appropriately according to the battery capacity and output.

### [Vehicle]

The lithium ion secondary battery or the assembled battery according to the present example embodiment can be used in vehicles. Examples of the vehicle according to an example embodiment of the present invention include hybrid vehicles, fuel cell vehicles, electric vehicles (besides four-wheel vehicles (cars, trucks, commercial vehicles such as buses, light automobiles, etc.), two-wheeled vehicle (bike) and tricycle), and the like. The vehicles according to the present example embodiment are not limited to automobiles, and the batteries may be used in a variety of power sources of other vehicles, such as a moving body like a train.

### EXAMPLES

Hereinafter, an embodiment of the present invention will be explained in details by using examples, but the present invention is not limited to these examples.

Abbreviations used in the following Examples will be described.
SBR: styrene butadiene rubber
PAA: polyacrylic acid (copolymer of acrylic acid and sodium acrylate)
TEP: triethyl phosphate
TMP: trimethyl phosphate
FEC: fluoroethylene carbonate (4-fluoro-1,3-dioxolan-2-one)
DFEC: trans-difluoroethylene carbonate
FE1: 1,1,2,2-tetrafluoroethyl 2,2,3,3-tetrafluoropropyl ether
EC: ethylene carbonate
DEC: diethyl carbonate
SUS: stainless steel foil
Cu: copper foil
high strength Cu: high strength copper foil
NCA: LiNi_{0.80}Co_{0.15}Al_{0.05}O₂

### (Evaluation of Self-Extinguishing Property of Electrolyte Solution)

In each of the following Examples and Comparative Examples, a glass fiber sheet was immersed in the electrolyte solution, and it was brought into contact with flame for 5 seconds using a gas burner. When the glass fiber sheet soaked with the electrolyte solution was brought away from the gas burner, the sample with which a flame was observed was judged to be “not having self-extinguishing (No)” and the sample with which no flame was observed was judged to be “having self-extinguishing (Yes)”.

### Comparative Example 1

When the self-extinguishing property of the electrolyte solution prepared by mixing TEP (triethyl phosphate) and FEC (fluoroethylene carbonate) at a ratio of 60:40 (volume ratio) was evaluated, a flame was observed and thus it was judged that the electrolyte solution has no self-extinguishing property.

### Example 1

The production of the battery of this example will be described.

### (Electrode)

A crystalline silicon alloy (alloy of silicon and boron, weight ratio of silicon:boron=99:1, median diameter: 1 μm, crystallite size: 200 nm, specific surface area: 12 m²/cm³) as an electrode active material and SBR as an electrode binder were weighed so that a weight ratio thereof was 85:15. They were kneaded with distilled water to obtain a slurry for the negative electrode mixture layer. The prepared negative electrode slurry was applied to one surface of an electrolytic copper foil having a thickness of 10 μm as a current collector so as to be a coating weight of 1 mg/cm², drided, and cut into a circular shape having a diameter of 12 mm to obtain a negative electrode. When this negative electrode is used, the 1 C current value is about 3 mAh.

The capacity of the negative electrode mixture layer may be calculated as follows. When the electrode was punched out into a circular shape with a diameter of 12 mm and the negative electrode active material was applied to one surface of the electrode so as to be a coating weight of 1 mg/cm², the initial charge capacity is follows. For example, if the capacity of the negative electrode active material is 3000 mAh/g and the amount of the negative electrode active material in the negative electrode mixture layer is 85% by weight, the negative electrode capacity excluding the binder (i.e. the capacity of the negative electrode mixture layer) is 3000 (mAh/g)×85/100=2550 (mAh/g). Therefore, the initial charge capacity is 2550 (mAh/g)×1 mg/cm²×(12 mm×0.5)²× Π=2.9 (mAh).

### (Production of the Battery)

A half-cell having a lithium metal as a counter electrode was produced using the obtained electrode. Triethyl phosphate (hereinafter abbreviated as TEP) and fluoroethylene carbonate (hereinafter abbreviated as FEC) were mixed at a ratio of 98:2 (volume ratio) as a non-aqueous solvent, and LiPF₆ as a supporting salt was dissolved therein at a concentration of 1 mol/L. The obtained electrolyte solution was used. As the separator, a PP (polypropylene) separator manufactured by Celgard was used.

The self-extinguishing property of the electrolyte solution was also evaluated (hereinafter, the self-extinguishing properties of the electrolyte solutions were also evaluated in all Examples and Comparative Examples).

### (Battery Evaluation)

As charging, CCCV charging was performed at 0.5 C current value to 0V, and CC discharging was performed at 0.5 C current value to 1V as discharge. Charge and discharge was repeated 10 times, and the capacity retention ratio after 10 cycles was calculated by the following formula:

{(discharge capacity after 10 cycles)/(discharge capacity after 1 cycle)}×100(unit:%)

The results are shown in Table 1.

### Example 2

A battery was prepared and evaluated in the same manner as in Example 1 except that the non-aqueous solvent of the electrolyte solution was changed to the ratio of TEP:FEC=90:10 (volume ratio).

### Example 3

A battery was prepared and evaluated in the same manner as in Example 2 except that the median diameter of the silicon alloy was changed to 0.5 μm.

### Example 4

A battery was prepared and evaluated in the same manner as in Example 3 except that the non-aqueous solvent of the electrolyte solution was changed to a mixture of TEP:FEC:FE1=70:10:20 (volume ratio).

### Example 5

A battery was prepared and evaluated in the same manner as in Example 4, except that the electrode active material was changed to a mixture of silicon alloy: SiO (having a median diameter of 5 μm): graphite (having a median diameter of 10 μm)=97:2:1 (weight ratio).

### Example 6

A battery was prepared and evaluated in the same manner as in Example 5 except that SBR as an electrode binder was replaced with a polyacrylic acid sodium salt (copolymer of acrylic acid and sodium acrylate, PAA) and the ratio was changed to “the electrode active material:PAA=85:15 (weight ratio)”.

### Example 7

A battery was prepared and evaluated in the same manner as in Example 6 except that the ratio was changed to “the electrode active material:PAA=70:30 (weight ratio)”.

### Example 8

A battery was prepared and evaluated in the same manner as in Example 7, except that the electrode current collector foil was changed to SUS foil.

### Example 9

A battery was prepared and evaluated in the same manner as in Example 8 except that the non-aqueous solvent in the electrolyte solution was changed to a mixture of TEP:FEC:FE1=65:5:30 (volume ratio).

### Example 10

A battery was prepared and evaluated in the same manner as in Example 8 except that the non-aqueous solvent in the electrolyte solution was changed to a mixture of TEP:FEC:FE1=60:10:30 (volume ratio).

### Example 11

A battery was prepared and evaluated in the same manner as in Example 8 except that the non-aqueous solvent in the electrolyte solution was changed to a mixture of TEP:FEC:FE1=85:5:10 (volume ratio).

### Example 12

A battery was prepared and evaluated in the same manner as in Example 8, except that the non-aqueous solvent in the electrolyte solution was changed to a mixture of TEP:FEC:FE1=80:10:10 (volume ratio).

### Example 13

A battery was prepared and evaluated in the same manner as in Example 8 except that the Si alloy of the electrode active material was changed to an alloy of Si and Al (Si:Al=99:1 (weight ratio)).

### Example 14

A battery was prepared and evaluated in the same manner as in Example 8 except that the Si alloy of the electrode active material was changed to an alloy of Si and P (Si:P=99:1 (weight ratio)).

### Example 15

A battery was prepared and evaluated in the same manner as in Example 8 except that the Si alloy of the electrode active material was changed to an alloy of Si and Ti (Si:Ti=99:1 (weight ratio)).

### Example 16

A battery was prepared and evaluated in the same manner as in Example 8 except that a lithium nickel oxide electrode was used as the counter electrode (positive electrode). The manufacturing method of the lithium nickel oxide electrode is described below. Lithium nickel oxide (LiNi_{0.80}Co_{0.15}Al_{0.05}O₂, also referred to as “NCA”) as a positive electrode active material, carbon black as an electrically conductive assistant agent, and polyvinylidene fluoride as a binder for the positive electrode were weighed so that a weight ratio thereof was 90:5:5, and they were mixed with n-methylpyrrolidone to obtain a positive electrode slurry. The positive electrode slurry was applied to an aluminum foil having a thickness of 20 μm. The coating weight was adjusted so that the capacity retention ratio of the negative electrode and the positive electrode which were opposed to each other was 1.1 to 1.2. After applying the slurry, it was dried and further pressed to produce a positive electrode. Based on the capacity of the positive electrode, a current value at which a single cell was fully charged in 1 hour was defined as a 1 C current value, and charge and discharge was performed at a 1/50 C current value in the range of 4.1 V to 3 V.

### Example 17

A battery was prepared and evaluated in the same manner as in Example 16 except that the high-strength copper foil (manufactured by JX Metals Co., Ltd.) was used as a negative electrode current collector foil.

### Example 18

A battery was prepared and evaluated in the same manner as in Example 8 except that TMP (trimethyl phosphate) was used in place of TEP in the electrolyte solution.

### Example 19

A battery was prepared and evaluated in the same manner as in Example 8 except that DFEC (trans-difluoroethylene carbonate) was used in place of FEC in the electrolyte solution.

### Comparative Example 2

A battery was prepared and evaluated in the same manner as in Example 1 except that the silicon alloy was changed to one having a median diameter of 5 μm and the non-aqueous solvent of the electrolyte solution was changed to a mixture of TEP:EC:DEC=70:9:21.

### Comparative Example 3

A battery was prepared and evaluated in the same manner as in Example 8 except that the non-aqueous solvent of the electrolyte solution was changed to a mixture of TEP:EC:DEC=70:9:21.

### Comparative Example 4

A battery was prepared and evaluated in the same manner as in Example 1 except that the silicon alloy was changed to one having a median diameter of 5 Jim.

### Comparative Example 5

A battery was prepared and evaluated in the same manner as in Example 8 except that the ratio was changed to “the electrode active material:PAA=92:8 (weight ratio)”.

### Comparative Example 6

A battery was prepared and evaluated in the same manner as in Example 8 except that the ratio was changed to “the electrode active material:PAA=40:60 (weight ratio)”.

### Comparative Example 7

A battery was prepared and evaluated in the same manner as in Example 8 except that the ratio was changed to “the electrode active material:PAA=40:60 (weight ratio)”, and the non-aqueous solvent of the electrolyte solution was changed to a mixture of TEP:FEC:FE1=60:5:35.

### Comparative Example 8

A battery was prepared and evaluated in the same manner as in Example 8 except that the non-aqueous solvent of the electrolyte solution was changed to a mixture of TEP:FEC:FE1=60:5:35.

The constitutions of the batteries and the evaluation results of Examples and Comparative Examples are shown in Tables 1 and 2. In Tables 1 and 2, the amount of each material (Si alloy, SiO, C) constituting the electrode active material represents the amount based on the total weight of the electrode active material, and “amount of active material in mixture layer” represents a weight ratio of the electrode active material based on the total weight of the electrode mixture layer (that is, the total weight of the electrode active material and the electrode binder). The amount of the binder represents the amount of each material based on the total weight of the electrode mixture layer.

### [Privileged and Confidential]

TABLE 1

| | electrode | | | | | | | | |
|---|---|---|---|---|---|---|---|---|---|
| | electrode mixture layer | | | | | | | | |
| | electrode active material | | | | | | | | |
| | Si alloy | | composition ratio in | | | amount of the | amount of binder | | |
| | D50 of | | active material (wt %) | | | active material | in mixture layer | | |
| | Si alloy | doping | Si | | | in mixture layer | (wt %) | | current |
| | (μm) | element | alloy | SiO | C | (wt %) | SBR | PAA | collector |
| Ex. 1 | 1 | B | 100 | 0 | 0 | 85 | 15 | 0 | Cu |
| Ex. 2 | 1 | B | 100 | 0 | 0 | 85 | 15 | 0 | Cu |
| Ex. 3 | 0.5 | B | 100 | 0 | 0 | 85 | 15 | 0 | Cu |
| Ex. 4 | 0.5 | B | 100 | 0 | 0 | 85 | 15 | 0 | Cu |
| Ex. 5 | 0.5 | B | 97 | 2 | 1 | 85 | 15 | 0 | Cu |
| Ex. 6 | 0.5 | B | 97 | 2 | 1 | 85 | 0 | 15 | Cu |
| Ex. 7 | 0.5 | B | 97 | 2 | 1 | 70 | 0 | 30 | Cu |
| Ex. 8 | 0.5 | B | 97 | 2 | 1 | 70 | 0 | 30 | SUS |
| Ex. 9 | 0.5 | B | 97 | 2 | 1 | 70 | 0 | 30 | SUS |
| Ex. 10 | 0.5 | B | 97 | 2 | 1 | 70 | 0 | 30 | SUS |
| Ex. 11 | 0.5 | B | 97 | 2 | 1 | 70 | 0 | 30 | SUS |
| Ex. 12 | 0.5 | B | 97 | 2 | 1 | 70 | 0 | 30 | SUS |
| Ex. 13 | 0.5 | Al | 97 | 2 | 1 | 70 | 0 | 30 | SUS |
| Ex. 14 | 0.5 | P | 97 | 2 | 1 | 70 | 0 | 30 | SUS |
| Ex. 15 | 0.5 | Ti | 97 | 2 | 1 | 70 | 0 | 30 | SUS |
| Ex. 16 | 0.5 | B | 97 | 2 | 1 | 70 | 0 | 30 | SUS |
| Ex. 17 | 0.5 | B | 97 | 2 | 1 | 70 | 0 | 30 | high- |
| | | | | | | | | | strength |
| | | | | | | | | | Cu |
| Ex. 18 | 0.5 | B | 97 | 2 | 1 | 70 | 0 | 30 | SUS |
| Ex. 19 | 0.5 | B | 97 | 2 | 1 | 70 | 0 | 30 | SUS |

| | | | | | | evaluation | |
|---|---|---|---|---|---|---|---|
| | | | | | | | capacity |
| | | | | | | self- | retention |
| | electrolyte solution | | | | | extinguishing | ratio of |
| | composition ratio (vol %) | | | | | property of | secondary |
| | | | | EC/DEC = | counter | electrolyte | battery |
| | TEP | FEC | FE1 | 3/7 | electrode | solution | (%) |
| Ex. 1 | 98 | 2 | 0 | 0 | Li | Yes | 41 |
| Ex. 2 | 90 | 10 | 0 | 0 | Li | Yes | 68 |
| Ex. 3 | 90 | 10 | 0 | 0 | Li | Yes | 70 |
| Ex. 4 | 70 | 10 | 20 | 0 | Li | Yes | 74 |
| Ex. 5 | 70 | 10 | 20 | 0 | Li | Yes | 75 |
| Ex. 6 | 70 | 10 | 20 | 0 | Li | Yes | 78 |
| Ex. 7 | 70 | 10 | 20 | 0 | Li | Yes | 82 |
| Ex. 8 | 70 | 10 | 20 | 0 | Li | Yes | 95 |
| Ex. 9 | 65 | 5 | 30 | 0 | Li | Yes | 91 |
| Ex. 10 | 60 | 10 | 30 | 0 | Li | Yes | 93 |
| Ex. 11 | 85 | 5 | 10 | 0 | Li | Yes | 90 |
| Ex. 12 | 80 | 10 | 10 | 0 | Li | Yes | 94 |
| Ex. 13 | 70 | 10 | 20 | 0 | Li | Yes | 88 |
| Ex. 14 | 70 | 10 | 20 | 0 | Li | Yes | 86 |
| Ex. 15 | 70 | 10 | 20 | 0 | Li | Yes | 92 |
| Ex. 16 | 70 | 10 | 20 | 0 | NCA | Yes | 95 |
| Ex. 17 | 70 | 10 | 20 | 0 | NCA | Yes | 91 |
| Ex. 18 | (TMP) | 10 | 20 | 0 | Li | Yes | 94 |
| | 70 | | | | | | |
| Ex. 19 | 70 | (DFEC) | 20 | 0 | Li | Yes | 93 |
| | | 10 | | | | | |

Ex. = Example

### [Privileged and Confidential]

TABLE 2

| | electrode | | | | | | | | |
|---|---|---|---|---|---|---|---|---|---|
| | electrode mixture layer | | | | | | | | |
| | electrode active material | | | | | | | | |
| | Si alloy | | composition ratio in | | | amount of | amount of binder | | |
| | D50 of | | active material (wt %) | | | active material | in mixture layer | | |
| | Si alloy | doping | Si | | | in mixture layer | (wt %) | | current |
| | (μm) | element | alloy | SiO | C | (wt %) | SBR | PAA | collector |
| Com. Ex. 1 | — | — | — | — | — | | — | — | — |
| (electrolyte | | | | | | | | | |
| solution only) | | | | | | | | | |
| Com. Ex. 2 | 5 | B | 100 | 0 | 0 | 85 | 15 | 0 | Cu |
| Com. Ex. 3 | 0.5 | B | 97 | 2 | 1 | 70 | 0 | 30 | SUS |
| Com. Ex. 4 | 5 | B | 100 | 0 | 0 | 85 | 15 | 0 | Cu |
| Com. Ex. 5 | 0.5 | B | 97 | 2 | 1 | 92 | 0 | 8 | SUS |
| Com. Ex. 6 | 0.5 | B | 97 | 2 | 1 | 40 | 0 | 60 | SUS |
| Com. Ex. 7 | 0.5 | B | 97 | 2 | 1 | 40 | 0 | 60 | SUS |
| Com. Ex. 8 | 0.5 | B | 97 | 2 | 1 | 70 | 0 | 30 | SUS |

| | | | | | | evaluation | |
|---|---|---|---|---|---|---|---|
| | | | | | | | capacity |
| | | | | | | self- | retention |
| | electrolyte solution | | | | | extinguishing | ratio of |
| | composition ratio (vol %) | | | | | property of | secondary |
| | | | | EC/DEC = | counter | electrolyte | battery |
| | TEP | FEC | FE1 | 3/7 | electrode | solution | (%) |
| Com. Ex. 1 | 60 | 40 | 0 | 0 | — | No | not |
| (electrolyte | | | | | | | evaluated |
| solution only) | | | | | | | |
| Com. Ex. 2 | 70 | 0 | 0 | 30 | Li | Yes | 3 |
| Com. Ex. 3 | 70 | 0 | 0 | 30 | Li | Yes | 1 |
| Com. Ex. 4 | 98 | 2 | 0 | 0 | Li | Yes | 25 |
| Com. Ex. 5 | 70 | 10 | 20 | 0 | Li | Yes | 18 |
| Com. Ex. 6 | 70 | 10 | 20 | 0 | Li | Yes | 9 |
| Com. Ex. 7 | 60 | 5 | 35 | 0 | Li | Yes | 22 |
| Com. Ex. 8 | 60 | 5 | 35 | 0 | Li | Yes | 25 |

Com. Ex. = Comparative Example

The whole or part of the example embodiments disclosed above can be described as, but not limited to, the following supplementary notes.

### (Supplementary Note 1)

A lithium ion secondary battery comprising an electrode and an electrolyte solution, wherein

the electrode comprises (i) an electrode mixture layer comprising an electrode active material and an electrode binder, and (ii) an electrode current collector;

the electrode active material comprises an alloy comprising silicon (Si alloy),

the Si alloy has a median diameter (D50 particle size) of 1.2 μm or less,

an amount of the electrode binder based on the weight of the electrode mixture layer is 12% by weight or more and 50% by weight or less; and

the electrolyte solution comprises:

60% by volume or more and 99% by volume or less of a phosphoric acid ester compound,

0% by volume or more and 30% by volume or less of a fluorinated ether compound, and

1% by volume or more and 35% by volume or less of a fluorinated carbonate compound, and wherein

the total amount of the phosphoric acid ester compound and the fluorinated ether compound is 65% by volume or more.

### (Supplementary Note 2)

The lithium ion secondary battery according to the supplementary note 1, wherein the electrolyte solution comprises 1% by volume or more and 30% by volume or less of a fluorinated ether compound.

### (Supplementary Note 3)

The lithium ion secondary battery according to the supplementary note 1 or 2, wherein an amount of the Si alloy based on the total weight of the electrode active material is 65% by weight or more.

(Supplementary note 4)

The lithium ion secondary battery according to any one of the supplementary notes 1 to 3, wherein the electrode binder comprises a polyacrylic acid.

(Supplementary note 5)

The lithium ion secondary battery according to any one of the supplementary notes 1 to 4, wherein the Si alloy is an alloy of Si and at least one selected from the group consisting of boron, aluminum, phosphorus, and titanium.

(Supplementary note 6)

The lithium ion secondary battery according to any one of the supplementary notes 1 to 5, wherein the electrode current collector is a stainless steel foil, a rolled copper foil, or a clad current collector foil.

(Supplementary note 7)

The lithium ion secondary battery according to any one of the supplementary notes 1 to 6, wherein the Si alloy is crystalline.

(Supplementary note 8)

The lithium ion secondary battery according to any one of the supplementary notes 1 to 7, wherein the electrode is a negative electrode.

(Supplementary note 9)

The lithium ion secondary battery according to the supplementary note 8, further comprising a positive electrode and wherein the positive electrode comprises a positive electrode active material represented by the following formula (A2):

Li_{y}Ni₍₁₋ₓ₎MₓO₂ (A2)

wherein in formula (A2), 0≤x≤1, 0≤y≤1, M is at least one element selected from the group consisting of Li, Co, Al, Mn, Fe, Ti, and B.

(Supplementary note 10)

An assembled battery comprising the lithium ion secondary battery according to any one of the supplementary notes 1 to 9.

(Supplementary note 11)

A vehicle comprising the lithium ion secondary battery according to any one of the supplementary notes 1 to 9.

(Supplementary note 12)

A method of manufacturing a lithium ion secondary battery comprising:

stacking a positive electrode and a negative electrode via a separator to prepare an electrode element, and

enclosing the electrode element and an electrolyte solution in an outer package, wherein

the negative electrode comprises (i) a negative electrode mixture layer comprising a negative electrode active material and a negative electrode binder, and (ii) a negative electrode current collector,

the negative electrode active material comprises an alloy comprising silicon (Si alloy),

the Si alloy has a median diameter (D50 particle size) of 1.2 μm or less,

an amount of the negative electrode binder based on the weight of the negative electrode mixture layer is 12% by weight or more and 50% by weight or less; and

the electrolyte solution comprises:

60% by volume or more and 99% by volume or less of a phosphoric acid ester compound,

0% by volume or more and 30% by volume or less of a fluorinated ether compound, and

1% by volume or more and 35% by volume or less of a fluorinated carbonate compound, and wherein

the total amount of the phosphoric acid ester compound and the fluorinated ether compound is 65% by volume or more.

(Supplementary note 13)

A lithium ion secondary battery comprising a negative electrode and an electrolyte solution, wherein

the negative electrode comprises (i) a negative electrode mixture layer comprising a negative electrode active material and a negative electrode binder, and (ii) a negative electrode current collector;

the negative electrode active material comprises an alloy comprising silicon (Si alloy),

the Si alloy has a median diameter (D50 particle size) of 1.2 μm or less,

an amount of the negative electrode binder based on the weight of the negative electrode mixture layer is 12% by weight or more and 50% by weight or less; and

the electrolyte solution comprises:

60% by volume or more and 99% by volume or less of a phosphoric acid ester compound,

0% by volume or more and 30% by volume or less of a fluorinated ether compound, and

1% by volume or more and 35% by volume or less of a fluorinated carbonate compound, and wherein

the total amount of the phosphoric acid ester compound and the fluorinated ether compound is 65% by volume or more.

This application is based upon and claims the benefit of priority from Japanese patent application No. 2017-227647, filed on Nov. 28, 2017, the disclosure of which is incorporated herein in its entirety by reference.

While the invention has been particularly shown and described with reference to example embodiments (and examples) thereof, the invention is not limited to these embodiments (and examples). It will be understood by those of ordinary skill in the art that various changes in form and details may be made therein without departing from the spirit and scope of the present invention as defined by the claims.

### INDUSTRIAL APPLICABILITY

The lithium ion secondary battery according to the present example embodiment can be utilized, for example, in various industrial fields that require for an electric power source and in an industrial field concerning transportation, storage and supply of electric energy. Specifically, it can be utilized for, for example, an electric power source of a mobile device such as a mobile phone and a notebook computer; an electric power source of a moving or transport medium including an electric vehicle such as an electric car, a hybrid car, an electric motorcycle and an electric power-assisted bicycle, a train, a satellite and a submarine; a back-up electric power source such as UPS; and an electric power storage device for storing an electric power generated by solar power generation, wind power generation; and the like.

### EXPLANATION OF REFERENCE

1 positive electrode mixture layer
2 negative electrode mixture layer
3 positive electrode current collector
4 negative electrode current collector
5 separator
6 exterior laminate
7 negative electrode lead terminal
8 positive electrode lead terminal
10 film outer package
20 battery element
25 separator
30 positive electrode
40 negative electrode

1. A lithium ion secondary battery comprising an electrode and an electrolyte solution, wherein
the electrode comprises (i) an electrode mixture layer comprising an electrode active material and an electrode binder, and (ii) an electrode current collector;
the electrode active material comprises an alloy comprising silicon (Si alloy),
the Si alloy has a median diameter (D50 particle size) of 1.2 μm or less,
an amount of the electrode binder based on the weight of the electrode mixture layer is 12% by weight or more and 50% by weight or less; and
the electrolyte solution comprises:
60% by volume or more and 99% by volume or less of a phosphoric acid ester compound,
0% by volume or more and 30% by volume or less of a fluorinated ether compound, and
1% by volume or more and 35% by volume or less of a fluorinated carbonate compound, and wherein
the total amount of the phosphoric acid ester compound and the fluorinated ether compound is 65% by volume or more.

2. The lithium ion secondary battery according to claim 1, wherein the electrolyte solution comprises 1% by volume or more and 30% by volume or less of a fluorinated ether compound.

3. The lithium ion secondary battery according to claim 1, wherein an amount of the Si alloy based on the total weight of the electrode active material is 65% by weight or more.

4. The lithium ion secondary battery according to claim 1, wherein the electrode binder comprises a polyacrylic acid.

5. The lithium ion secondary battery according to claim 1, wherein the Si alloy is an alloy of Si and at least one selected from the group consisting of boron, aluminum, phosphorus, and titanium.

6. The lithium ion secondary battery according to claim 1, wherein the electrode current collector is a stainless steel foil, a rolled copper foil, or a clad current collector foil.

7. The lithium ion secondary battery according to claim 1, wherein the Si alloy is crystalline.

8. The lithium ion secondary battery according to claim 1, wherein the electrode is a negative electrode.

9. The lithium ion secondary battery according to claim 8, further comprising a positive electrode and wherein the positive electrode comprises a positive electrode active material represented by the following formula (A2):
Li_{y}Ni₍₁₋ₓ₎MₓO₂ (A2)
wherein in formula (A2), 0≤x≤1, 0≤y≤1, M is at least one element selected from the group consisting of Li, Co, Al, Mn, Fe, Ti, and B.

10. An assembled battery comprising the lithium ion secondary battery according to any one of claim 1.

11. A vehicle comprising the lithium ion secondary battery according to claim 1.

12-13. (canceled)
